(19) United States
(12) Patent Application Publication
(10) Pub. No.: US 2025/0316989 A1
(43) Pub. Date: Oct. 9, 2025

(54) POWER STORAGE DEVICE

(71) Applicant: TOYOTA JIDOSHA KABUSHIKI KAISHA, Toyota-shi (JP)

(72) Inventors: Junya KOBAYASHI, Ama-shi (JP); Yoshihiko HIROE, Toyota-shi (JP); Masanori SHINOHARA, Okazaki-shi (JP)

(73) Assignee: TOYOTA JIDOSHA KABUSHIKI KAISHA, Toyota-shi (JP)

(21) Appl. No.: 19/059,441

(22) Filed: Feb. 21, 2025

(30) Foreign Application Priority Data
Apr. 8, 2024 (JP) 2024-062214

(51) Int. Cl. H02J 7/00; G06F 21/32; G08B 13/14; H01M 50/256; H01M 50/576

(52) U.S. Cl. CPC H02J 7/00045; G06F 21/32; G08B 13/14; H01M 50/256; H01M 50/576

(57) ABSTRACT

A power storage device includes a case, a storage battery accommodated within the case, and a processor that controls energization of the storage battery, and the processor being configured to: store first authentication information associated with a specific user, read second authentication information from an arbitrary user, check whether or not the second authentication information and the first authentication information match with each other, and provide an alert about a check result.

### CROSS-REFERENCE TO RELATED APPLICATION

This application is based on and claims priority under 35 USC 119 from Japanese Patent Application No. 2024-062214 filed on Apr. 8, 2024, the disclosure of which is incorporated by reference herein.

### BACKGROUND

### Technical Field

The present disclosure relates to a power storage device.

### Related Art

Power storage devices are widely used as power sources for various machines (hereinafter, these are referred to as “machine bodies”) including vehicles, such as automobiles and the like, and communication terminals, such as smartphones and the like. Such power storage devices are relatively expensive and have a risk of being stolen.

Japanese Patent Application Laid-Open (JP-A) No. 2017-041443 describes a power storage device provided with functionality to detect theft or the like and provide an alert to an exterior of the power storage device. This power storage device includes a storage battery, a movement detector that detects movement of the power storage device, an alarm that provides an alert to the exterior for an abnormality in the power storage device, and a controller that causes the alarm to provide an alert that there is an abnormality when movement of the power storage device is detected by the movement detector while the storage battery is not discharging.

In Japanese Patent Application Laid-Open (JP-A) No. 2017-041443, it is determined that an abnormality has occurred in the power storage device in a case in which communication with an information terminal of a user of the power storage device by a communication device that performs short-range wireless communication with the information terminal is not possible. In this case, when a legitimate user is not in possession of the information terminal, it is determined that an abnormality has occurred in the power storage device even in a case in which the legitimate user has moved the power storage device.

### SUMMARY

In consideration of the above-described problem, the present disclosure provides a power storage device that is capable of detecting an abnormality, such as theft or the like, without requiring communication with the exterior.

A power storage device according to a first aspect of the present disclosure includes a case, a storage battery accommodated within the case, and a control device that controls energization of the storage battery, and the control device includes a storage section that stores first authentication information associated with a specific user, a reading section that reads second authentication information from an arbitrary user, an authentication section that checks whether or not the second authentication information and the first authentication information match with each other, and an alert section that provides an alert about an authentication result by the authentication section.

In the power storage device according to the first aspect, occurrence of theft of the power storage device can be detected by the power storage device alone.

A power storage device according to a second aspect of the present disclosure is the power storage device according to the first aspect of the present disclosure, wherein the control device permits energization of the storage battery when the storage battery is connected to a machine body after the second authentication information and the first authentication information have matched with each other at the authentication section.

In the power storage device according to the second aspect, it is possible to prevent anyone other than a legitimate owner from using the power storage device.

A power storage device according to a third aspect of the present disclosure is the power storage device according to the first aspect or second aspect of the present disclosure, wherein the case includes a gripping portion, and the reading section is installed at the gripping portion and reads biometric information of a user, who has gripped the gripping portion, as the second authentication information.

In the power storage device according to the third aspect, checking by the authentication section can be easily performed simply by grasping the gripping portion that is gripped when carrying the power storage device.

A power storage device according to a fourth aspect is the power storage device according to any one of the first aspect to the third aspect of the present disclosure, further including an energization permission determination section that determines whether or not to permit energization with an exterior of the storage battery, based on the authentication result by the authentication section.

In the power storage device according to the fourth aspect, control such as not permitting energization of the storage battery unless the authentication result is satisfactory is possible, and unauthorized use of the power storage device can be suppressed.

According to the power storage device of the present disclosure, an abnormality, such as theft or the like, can be detected without requiring communication with the exterior.

### BRIEF DESCRIPTION OF THE DRAWINGS

Exemplary embodiments of the present disclosure will be described in detail based on the following figures, wherein:

FIG. 1 is a schematic diagram schematically illustrating an example of a power storage device according to an exemplary embodiment;

FIG. 2 is a functional block diagram illustrating an example of functionality of a control device within the power storage device of FIG. 1;

FIG. 3 is a flow chart illustrating an example of an authentication process in the power storage device of FIG. 1;

FIG. 4 is a schematic diagram schematically illustrating an example of a power storage device according to a modified example;

FIG. 5 is a flow chart illustrating an example of a connection operation in the power storage device of FIG. 4; and

FIG. 6 is a flow chart illustrating an example of a connection release operation in the power storage device of FIG. 4.

### DETAILED DESCRIPTION

The present disclosure will become more fully understood from the detailed description given hereinbelow. Further range of application of the present disclosure will become clearer from the detailed description given hereinbelow. However, the detailed description and the specific embodiment are illustrated of desired embodiments of the present disclosure and are described only for the purpose of explanation. Various changes and modifications will be apparent to those ordinary skilled in the art on the basis of the detailed description.

The applicant has no intention to give to public any disclosed embodiment. Among the disclosed changes and modifications, those which may not literally fall within the scope of the patent claims constitute, therefore, a part of the present disclosure in the sense of doctrine of equivalents.

Respective exemplary embodiments for implementing the present disclosure will be explained below, with reference to the drawings. In the following, a range necessary for description for achieving the object of the disclosure will be schematically illustrated, a range necessary for description of a corresponding portion of the disclosure will be mainly described, and portions for which description is omitted will be based on known technologies. Further, members that are identical or equivalent to each other in the drawings are allocated identical or similar reference numerals, and duplicate explanation thereof is omitted. Moreover, in cases in which plural members that are identical or equivalent to each other are included in the drawings, reference numerals may be allocated to only some of the members in order to facilitate viewing of the drawings.

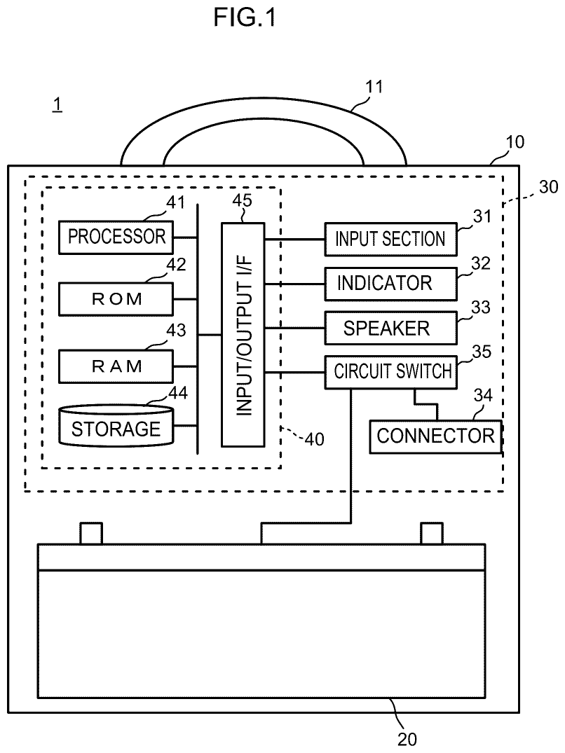

FIG. 1 is a schematic diagram schematically illustrating an example of a power storage device according to an exemplary embodiment. The power storage device 1 according to the present exemplary embodiment may be a portable power storage device that is installed so as to be freely seated at a machine body such as, for example, a vehicle, and that can be used as a power source for various devices within the vehicle. As illustrated in FIG. 1, this power storage device 1 includes at least a case 10, a storage battery 20 accommodated within the case 10, and a control device 30 that controls energization of the storage battery 20.

The case 10 can be configured by a box-shaped member made of synthetic resin or metal, at an interior of which the storage battery 20 and the control device 30 are accommodated. A handle 11 serving as an example of a gripping portion that a user grips when carrying the power storage device 1 may be provided at an upper portion of the case 10. It should be noted that an arrangement of the handle 11 is not limited to that which is illustrated in FIG. 1, and one or more handles 11 may be provided at appropriate locations at the case 10.

The storage battery 20 can be configured by a secondary battery that is capable of being charged and discharged, typified by a lithium ion battery. Discharging or charging of the storage battery 20 is carried out due to the storage battery 20 being connected to a machine body or a power source device via a connector 34, which will be described below.

The control device 30 can be configured by a device that is provided with user authentication functionality for detecting an abnormality such as theft or the like, in addition to controlling the energization of the storage battery 20. The control device 30 may include an input section 31, an indicator 32, a speaker 33, the connector 34, a circuit switch 35, and a control device main body 40.

The input section 31 can be configured by a user interface that enables a user to input various information, and can be one that enables input of at least second authentication information that is used for user authentication. Specific examples of the input section 31 include a physical switch that can be operated by inserting a key for authentication, a numeric keypad or a touch panel by which a predetermined code can be input, and the like.

The indicator 32 and the speaker 33 are devices for providing an alert when an abnormality, such as theft or the like, is detected. The indicator 32 can be configured by an illumination device such as, for example, an LED or the like. Further, the speaker 33 can be configured by an arbitrary acoustic device. It should be noted that, although the indicator 32 and the speaker 33 described above are exemplified as a means for providing an alert when an abnormality has been detected in the present exemplary embodiment, other means for providing an alert such as, for example, a display or a communication means that provides notification of the occurrence of an abnormality to a predetermined communication destination may be used in place of, or in addition to, the indicator 32 and the speaker 33.

The connector 34 can be configured by a plug connector or a receptacle connector that can be connected to a machine body or a power source device. Mechanical connection of the connector 34 can be detected by a sensor, which is not illustrated in the drawings. Further, the circuit switch 35 can be configured by a switch that is capable of permitting or not permitting energization between the machine body connected to the above-described connector 34 and the storage battery 20. It should be noted that, in a case in which the connector 34 has been connected to the power source device, it is preferable to always permit energization by the circuit switch 35, but there is no limitation thereto. Furthermore, a well-known circuit breaker can be adopted in place of the circuit switch 35.

The control device main body 40 can be configured by a computer including a microcontroller or the like. The computer may include, for example, a processor 41, a read only memory (ROM) 42 and a random access memory (RAM) 43, as examples of memory, a storage 44, and an input/output interface 45. Further, these configurations may be connected via an internal bus so as to be capable of communicating with each other.

The processor 41 is configured by, for example, a central processing unit (CPU), and may be capable of executing various programs and controlling various sections. More specifically, the processor 41 may be configured to be able to read out various programs stored in the ROM 42 or the storage 44, and execute the programs using the RAM 43 as a workspace. The processor 41 may be configured to be able to control various constituent elements configuring the power storage device 1 and perform various arithmetic processing, according to programs.

The ROM 42 may be configured to be able to store various programs and various data. Further, the RAM 43 may be configured to be able to serve as a workspace to temporarily store programs and data.

The storage 44 can be configured by a recording medium such as a hard disk drive (HDD), a solid state drive (SSD), or a flash memory, and may be configured to store various programs including an operating system, and various data required to operate the power storage device 1.

The input/output interface (I/F) 45 may be an interface for transmitting and receiving data and the like to and from various constituent elements of the control device 30. As illustrated in FIG. 1, the input/output interface 45 of the present exemplary embodiment can acquire or transmit predetermined data from, for example, the input section 31, the indicator 32, the speaker 33, and the circuit switch 35. The constituent elements from which the input/output interface 45 acquires data or constituent elements to which the data is output are not limited to those which are described above.

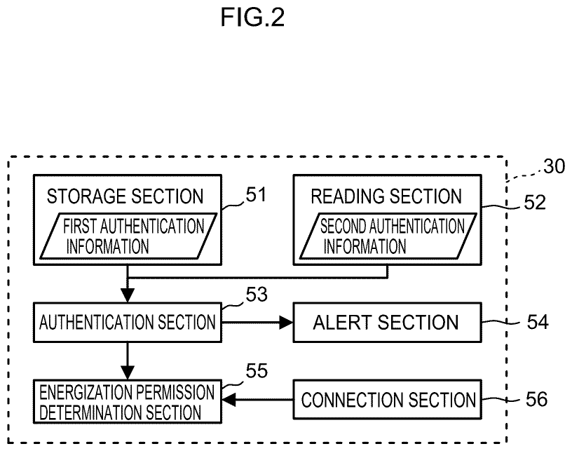

FIG. 2 is a functional block diagram illustrating an example of functionality of a control device within the power storage device of FIG. 1. The control device 30 of the present exemplary embodiment includes functionality such as illustrated in FIG. 2. More specifically, the control device 30 includes a storage section 51, a reading section 52, an authentication section 53, and an alert section 54. In addition, the control device 30 of the present exemplary embodiment may further include an energization permission determination section 55 and a connection section 56.

The storage section 51 can be implemented mainly by the storage 44, and stores first authentication information configured by at least information relating to a legitimate owner of the power storage device 1. The first authentication information can be provided in a format such as, for example, a password that has been set by a legitimate owner or an insertion hole that has a shape allowing insertion of a key for authentication and that is disposed adjacent to a physical switch. Further, the reading section 52 can be implemented mainly by the input section 31, and reads the second authentication information, which is input by a user who operates the power storage device 1. The second authentication information may be set according to the first authentication information that has been stored in the storage section 51. More specifically, this may be the password or the key for authentication.

It should be noted that the first authentication information can include, for example, information that has been set by the legitimate owner of the power storage device 1, as well as authentication information associated with a valid user who has been approved by the legitimate owner. Operation for adding such first authentication information may be performed, for example, by the legitimate owner via the input section 31 or via a terminal device or the like, which is not illustrated in the drawings, that is capable of communicating with the power storage device 1.

The authentication section 53 can be implemented mainly by the processor 41, and checks the first authentication information stored in the storage section 51 against the second authentication information read by the reading section 52 to determine whether or not they match with each other. Further, the alert section 54 can be implemented mainly by the indicator 32 and the speaker 33, and alerts the user or the like, who has input the second authentication information, of an authentication result by the authenticating section 53.

The energization permission determination section 55 can be implemented mainly by the processor 41 and the storage 44, and, based on the authentication result by the authentication section 53, determines whether or not to permit energization with an exterior of the storage battery 20. The energization permission determination section 55 of the present exemplary embodiment switches the circuit switch 35 to ON only in a case in which the first authentication information and the second authentication information match with each other according to the authentication section 53, so as to permit energization with the exterior of the storage battery 20, and more specifically, with the machine body. Further, the connection section 56 can be implemented by a sensor, which is not illustrated in the drawings, that is provided at the connector 34, and detects whether or not the connector 34 is connected to the machine body. A result that has been detected by the connection section 56 may be sent to the energization permission determination section 55.

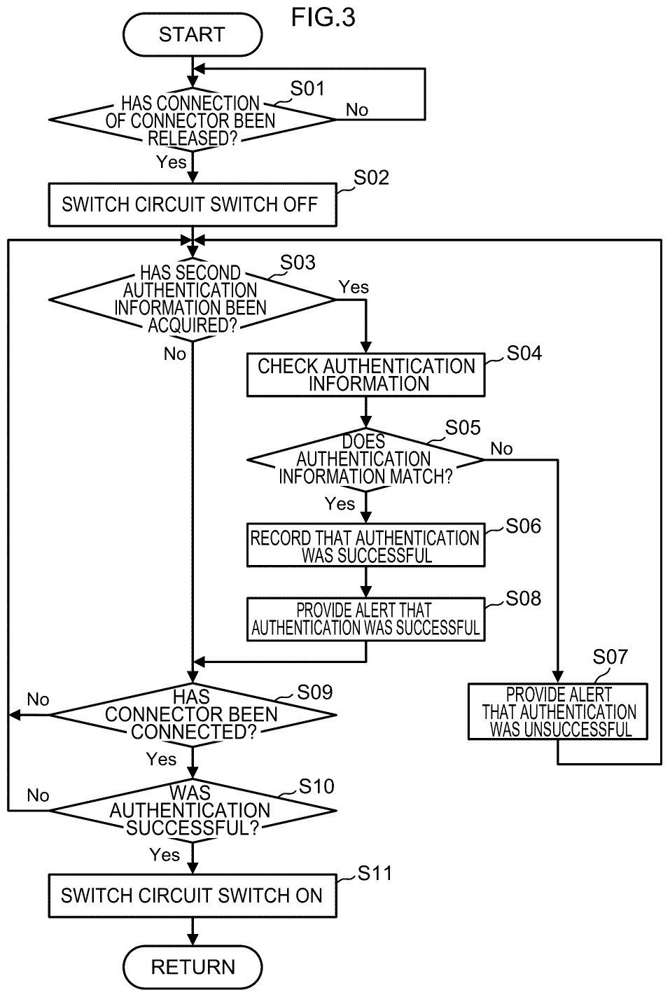

An authentication process employing the power storage device 1 provided with the configuration described above will be explained mainly with reference to FIG. 3. The authentication process can be implemented mainly by the control device 30.

FIG. 3 is a flowchart illustrating an example of an authentication process at the power storage device of FIG. 1. In the power storage device 1 according to the present exemplary embodiment, before a series of authentication processes are started, the legitimate owner is requested in advance to set the first authentication information, and the set first authentication information is stored in the storage section 51. Further, in the following explanation, it is assumed that the power storage device 1 is in a state of being connected to the machine body at a point in time when the authentication process is started.

When release of a connection state of the connector 34 is detected by the connection section 56 in a state in which the power storage device 1 is operating (step S01), the control device 30 switches the circuit switch 35 to OFF to end energization (step S02). Consequently, the power storage device 1 can be separated from the connected machine body.

When the connection of the power storage device 1 is released, a state in which the second authentication information can be read by the reading section 52 is attained. At this time, when the second authentication information is input from an arbitrary user via the input section 31 (step S03: YES), the control device 30 starts authentication processing.

When the authentication processing is started, first, the second authentication information that has been read by the reading section 52 is checked against the first authentication information stored in the storage section 51, at the authentication section 53 (step S04). In a case in which, as a result of this checking, the authentication information matches with each other (step S05: Yes), the control device 30 causes the energization permission determination section 55 to store information that authentication was successful (step S06), and causes the alert section 54 to provide an alert to the user that authentication was successful (step S08). The information indicating that authentication was successful stored in the energization permission determination section 55 may be held until connection of the connector 34 is detected again, or, for example, may be deleted when a predetermined period of time has elapsed.

On the other hand, in a case in which, as a result of the checking, the authentication information does not match (step S05: NO), the control device 30 causes the alert section 54 to provide an alert to the user that authentication was unsuccessful (step S07). In a case in which authentication was unsuccessful, the flow returns to step S03, and the state in which the second authentication information can be input is restored again.

When the power storage device 1 that has been separated from the machine body is connected to the machine body again (step S09: Yes), it is determined whether or not information indicating that authentication was successful is stored in the energization permission determination section 55 (step S10). In a case in which, as a result of the determination, information indicating that authentication was successful has not been stored, the control device 30 causes the energization permission determination section 55 to not permit energization of the storage battery 20, and returns to step S03 to request the second authentication information. On the other hand, in a case in which, as a result of the determination, information indicating that authentication was successful has been stored, the control device 30 causes the energization permission determination section 55 to permit energization of the storage battery 20, and switches the circuit switch 35 to the ON state (step S11).

As explained above, according to the power storage device 1 according to the present exemplary embodiment, the control device 30 within the power storage device 1 can complete the authentication process without requiring any other information terminal or the like. Consequently, an abnormality such as theft or the like can be detected with good precision.

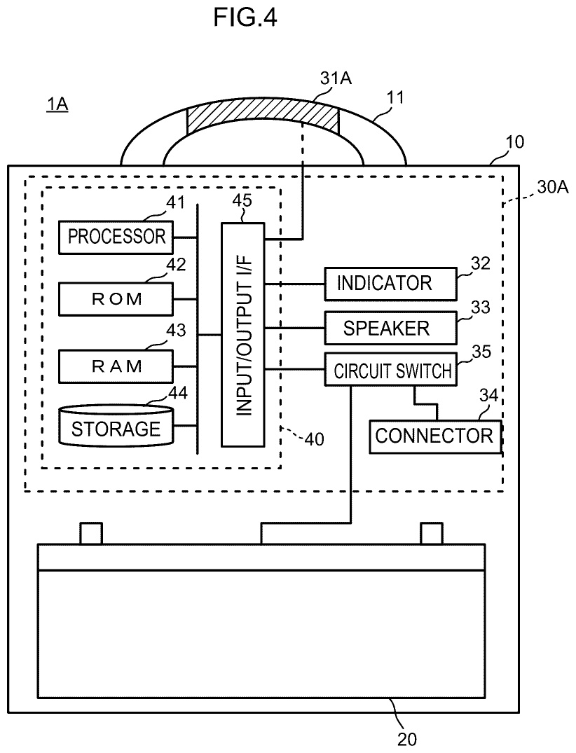

Although an example in which a physical switch or a numeric keypad is used as the input section 31 has been explained in the above-described exemplary embodiment, other input means can be employed. Further, although a case in which the authentication processing is executed at the time of a state in which connection of the power storage device 1 to the machine body has been released has been exemplified in the above-described exemplary embodiment, a timing of execution of the authentication processing is not limited thereto. In this regard, a modified example of the present exemplary embodiment will be explained below with reference to FIG. 4 to FIG. 6.

FIG. 4 is a schematic diagram schematically illustrating an example of a power storage device according to a modified example. As illustrated in FIG. 4, a power storage device 1A of the present modified example differs from the power storage device 1 of the exemplary embodiment mainly in that a biometric information acquisition section 31A provided at a portion of the handle 11 is employed in place of the input section 31 of the above-described exemplary embodiment. It should be noted that, for the power storage device 1A of the modified example described below, constituent elements that are similar to those of the power storage device 1 according to the above-described exemplary embodiment are allocated the same reference numerals, that explanation thereof is omitted, and that explanation will be centered on the portions that are different.

The biometric information acquisition section 31A is capable of acquiring biometric information that is unique to a user from a finger of the user. The biometric information can include, for example, information relating to a fingerprint or a vein. The biometric information acquisition section 31A may be disposed at an appropriate location at the handle 11 in consideration of an arrangement of the user's fingers when gripping the handle 11.

According to the power storage device 1A of the present modified example, in addition to the advantageous effects exerted by the power storage device 1 of the above-described exemplary embodiment, authentication processing can be performed simply by grasping the handle 11 without performing any particular operation in order to input second authentication information.

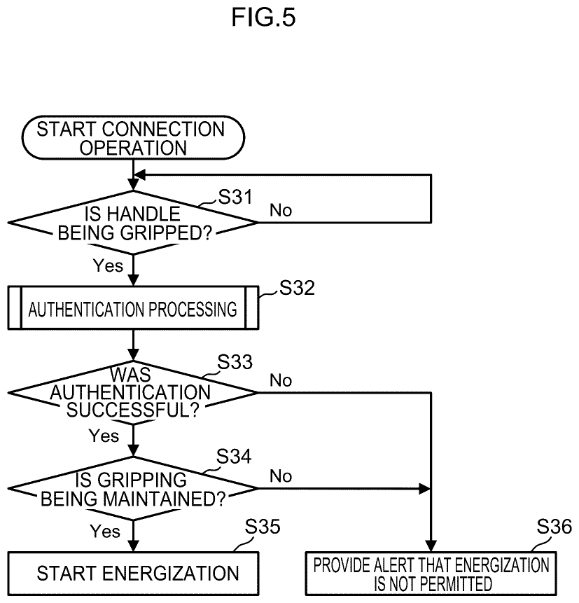

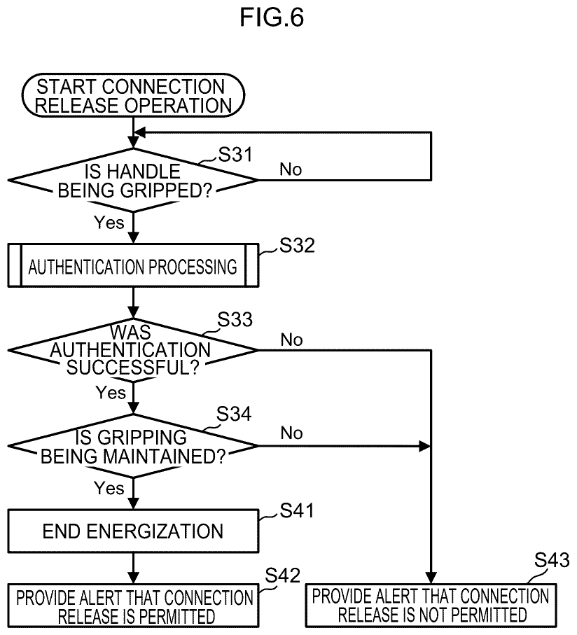

With regard to an authentication process using the power storage device 1A provided with the configuration described above, a process in a case of connecting to a machine body will be explained below with reference mainly to FIG. 5, and a process in a case of releasing connection with the machine body will be explained below with reference mainly to FIG. 6. It should be noted that, except for the steps performed by the biometric information acquisition section 31A, the authentication process explained below can also be implemented at the power storage device 1 of the exemplary embodiment described above.

FIG. 5 is a flowchart illustrating an example of connection operation at the power storage device of FIG. 4. First, operation for connecting the power storage device 1A and the machine body will be explained with reference to FIG. 5. When the operation for connecting the power storage device 1A to the machine body is started from a state in which the power storage device 1A is separated from the machine body, and connection of the connector 34 is detected at the connection section 56, the control device 30 first detects whether or not the handle 11 is being gripped in a state in which biometric information can be acquired at the biometric information acquisition section 31A (step S31). When it is detected that the handle 11 is being gripped (step S31: Yes), the control device 30 starts the authentication processing (step S32). The authentication processing referred to here is similar to the processing explained as steps S04 to S08 in the above-described exemplary embodiment. Furthermore, in a case in which the handle 11 is not being gripped in a state in which biometric information can be acquired (step S31: NO), the control device 30 does not start the authentication processing. At this time, in a case in which, for example, a gripping position of the handle 11 is shifted from a position at which the biometric information acquisition section 31A is provided or the like, the user may be notified of this fact via the indicator 32 or the speaker 33.

When the authentication processing is completed, the control device 30 determines whether or not information indicating that authentication was successful is stored in the energization permission determination section 55 (step S33). In a case in which, as a result of the determination, information indicating that authentication was successful is not stored (step S33: No), the control device 30 causes the energization permission determination section 55 to not permit energization of the storage battery 20, switches the circuit switch 35 to OFF, and causes the alert section 54 to provide an alert to the user that energization is not permitted (step S36).

On the other hand, in a case in which, as a result of the determination, information indicating that authentication was successful is stored (step S33: Yes), the control device 30 next determines whether or not a state of gripping of the handle 11 is being maintained (step S34). In a case in which the state of gripping of the handle 11 is being maintained (step S34: Yes), the control device 30 causes the energization permission determination section 55 to permit energization of the storage battery 20, switches the circuit switch 35 to the ON state, and starts energization from the storage battery 20 (step S35). On the other hand, in a case in which the state of gripping of the handle 11 has not been maintained (step S34: No), the control device 30 causes the energization permission determination section 55 to not permit energization of the storage battery 20, switches the circuit switch 35 to OFF, and causes the alert section 54 to provide an alert that energization is not permitted (step S36).

FIG. 6 is a flowchart illustrating an example of a connection release operation at the power storage device of FIG. 4. Next, operation for releasing connection between the power storage device 1A and the machine body will be explained with reference to FIG. 6. It should be noted that, since this operation shares many portions of the steps illustrated in FIG. 5 described above, the same reference numerals are allocated to steps that are similar to the steps illustrated in FIG. 5, and the above explanation will be repurposed for the details of the respective steps. When the operation for releasing connection with the machine body is started from a state in which the power storage device 1A is connected to the machine body, the control device 30 first detects whether or not the handle 11 is being gripped in a state in which biometric information can be acquired at the biometric information acquisition section 31A (step S31). In a case in which the handle 11 is being gripped (step S31: Yes), the control device 30 starts authentication processing (step S32). On the other hand, in a case in which the handle 11 is not being gripped in a state in which biometric information can be acquired (step S31: NO), the control device 30 does not start authentication processing.

When the authentication processing is completed, the control device 30 determines whether or not information indicating that authentication was successful is stored in the energization permission determination section 55 (step S33). In a case in which, as a result of the determination, information indicating that authentication was successful is not stored (step S33: No), the control device 30 causes the energization permission determination section 55 to not permit release of connection of the power storage device 1A, and causes the alert section 54 to provide an alert to the user that release of the connection is not permitted (step S43).

On the other hand, in a case in which, as a result of the determination, information indicating that authentication was successful is stored (step S33: Yes), the control device 30 next determines whether or not a state of gripping of the handle 11 has been maintained (step S34). In a case in which the state of gripping of the handle 11 has been maintained (step S34: Yes), the control device 30 switches the circuit switch 35 to an OFF state to end energization (step S41), and causes the alert section 54 to provide an alert to the user that release of connection between the power storage device 1A and the machine body is permitted (step S42). On the other hand, in a case in which the state of gripping of the handle 11 has not been maintained (step S34: No), the control device 30 does not permit release of connection of the power storage device 1A, and causes the alert section 54 to provide an alert to the user that release of connection is not permitted (step S43).

If the authentication processing is executed not only at a timing at which the power storage device 1A and the machine body are connected, but also at a timing at which connection between the power storage device 1A and the machine body is released, as in the power storage device 1A of the present modified example, an alert can be provided at a timing at which the power storage device 1A is separated from the machine body. Consequently, the power storage device 1A can be expected to have not only an advantageous effect of preventing unauthorized use thereof, but also an advantageous effect of preventing the power storage device 1A from being carried away. Furthermore, since permission for energization and permission for release of connection are only given in a case in which the handle 11 is in a state of being gripped, unauthorized use and the like can be effectively suppressed.

In relation to the provision of an alert that release of connection is not permitted that is indicated in step S43 described above, a lock mechanism that maintains a state of connection with the machine body can be provided at the power storage device 1A, and control such as not releasing locking of the lock mechanism in a case in which an alert that release of connection is not permitted has been provided can also be added. If such a lock mechanism is provided, carrying away of the power storage device 1A can be suppressed more effectively.

The present disclosure is not limited to the exemplary embodiments described above, and various modifications can be implemented within a range that does not depart from the spirit of the present disclosure. Further, these are all included in the technical idea of the present disclosure. Furthermore, unless otherwise specified in the specification, the respective constituent elements of the present disclosure are not limited to being singular and may be plural.

Further, in the above exemplary embodiments, the processor refers to a processor in a broad sense, and includes general purpose processors (such as, for example, a CPU or the like) and dedicated processors (such as, for example, a graphics processing unit (GPU), an application specific integrated circuit (ASIC), a field programmable gate array (FPGA), a programmable logic device, or the like).

Furthermore, operation of the processor in the above exemplary embodiments is not limited to being performed by a single processor, and may be performed by cooperation of plural processors present at physically separated positions. Further, the order of respective operation of the processors is not limited to only the order described in the above exemplary embodiments, and may be modified as appropriate.

The programs described above can be provided as a program product. The program product includes any form of product for providing a program. For example, the program product may include a program provided over a network such as the internet, a non-transitory computer-readable recording medium such as a CD-ROM, a DVD, or the like that stores the program, and the like.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the disclosure (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. A power storage device comprising:
a case;
a storage battery accommodated within the case; and
a processor that controls energization of the storage battery, wherein the processor being configured to:
store first authentication information associated with a specific user,
read second authentication information from an arbitrary user,
check whether or not the second authentication information and the first authentication information match with each other, and
provide an alert about a check result.

2. The power storage device according to claim 1, wherein the processor is further configured to permit energization of the storage battery when the storage battery is connected to a machine body after the second authentication information and the first authentication information have matched with each other.

3. The power storage device according to claim 1, wherein the case includes a gripping portion, and
the processor is further configured to read biometric information of a user, who has gripped the gripping portion, as the second authentication information.

4. The power storage device according to claim 1, wherein the processor is further configured to determine whether or not to permit energization with an exterior of the storage battery, based on the check result.
